(19) United States
(12) Patent Application Publication
(10) Pub. No.: US 2019/0202717 A1
(43) Pub. Date: Jul. 4, 2019

(54) PIEZOELECTRIC DEIONIZATION SYSTEM

(71) Applicant: Signal One International IP, LLC, Dallas, TX (US)

(72) Inventor: James Albert COATES, Casper, WY (US)

(21) Appl. No.: 15/164,984

(22) Filed: May 26, 2016

Related U.S. Application Data
(60) Provisional application No. 62/168,349, filed on May 29, 2015.

(51) Int. Cl. C02F 1/469; B01D 69/02; B01D 71/02; B01D 24/28

(52) U.S. Cl. CPC C02F 1/469; B01D 69/02; C02F 2103/08; B01D 24/28; B01D 71/027

(57) ABSTRACT

A piezoelectric deionization system uses a piezoid bed made up of multiple piezoids for deionization of a working fluid containing charged particles, ions, and/or ionic complexes. The working fluid may be salt water in various embodiments. A uniaxial compressive force is applied to the piezoid bed causing a piezoelectric effect in the piezoids, resulting in a piezoelectric field generated by each particle, which attracts charged particles, ions, and/or ionic complexes contained in the working fluid. The piezoid bed is contained in a closed chamber to which the uniaxial compressive force is applied. Monocrystalline quartz particles or another suitable piezoid, natural or synthetic, may be used. A fluid is used to purge the piezoid bed of charged particles, ions, and/or ionic complexes after the piezoid bed becomes saturated through use. The working fluid may be used to purge the piezoid.

### CROSS-REFERENCE TO RELATED APPLICATIONS

This patent application claims priority to and the benefit of U.S. Provisional Patent Application No. 62/168,349, filed May 29, 2015. The contents of these priority applications are hereby incorporated by reference herein in their entirety.

### FIELD OF THE VARIOUS EMBODIMENTS

The systems and methods described herein relate to use of a piezoelectric system for removal of ions, ionic complexes, and/or charged particles from a fluid. Specific embodiments include a deionization system for desalinating salt water (brine) to produce potable water.

### BACKGROUND

The demand for fresh water is becoming a critical issue in many nations of the world. Providing pure, fresh water to a burgeoning population of domestic, agricultural and industrial users is becoming increasingly difficult as existing sources of fresh water are stressed to their limits.

Paradoxically, the oceans of the world contain millions of cubic miles of salt water unfit for human consumption. In addition to the oceans, vast amounts of brackish waters and salt brines exist in underground aquifers beneath some of the most parched and barren deserts on earth.

In addition to the high salt content of the seas, many sources of fresh water have been contaminated with heavy metals from industrial waste. Many, once pristine waters, are now too toxic to consume.

Many desalination plants are in operation today producing millions of gallons of potable water from the sea, but the associated high capital and operating costs of these facilities prevent all but the wealthiest nations from using the current technologies. These and other deficiencies exist.

### SUMMARY OF THE VARIOUS EMBODIMENTS

Exemplary embodiments include a system for deionization of a working fluid having a plurality of piezoid particles contained in a chamber through which the working fluid containing charged particles, ions, and/or ionic complexes is passed. The piezoid particles form a bed through which the working fluid can pass. A force is applied to the piezoid particles to induce a piezoelectric effect in each particle which attracts charged particles, ions, and/or ionic complexes contained in the working fluid. The deionized fluid (working fluid that has passed through the bed of piezoid particles and has all or part of the charged particles, ions, and/or ionic complexes pulled out of the working fluid by the piezoids) is exhausted from the chamber. At a certain interval, the applied force is relieved and the chamber is flushed or purged to remove the charged particles, ions, and/or ionic complexes, that were removed from the working fluid, from the bed of piezoid particles. This flushing fluid is separately exhausted from the chamber. The flushing fluid may be different from the working fluid. The cycle is repeated in a pulsed manner. The working fluid and the flushing fluid may be liquid or gas or a combination thereof.

Exemplary embodiments further include a system for alignment of piezoid particles having container containing a fluid into which a plurality of piezoid particles are introduced. The piezoid particles, following introduction, each transit (descend) through the fluid. The fluid used has certain properties to facilitate the orderly flow through and movement of the piezoid particles, such as low viscosity and a density less than that of the piezoid particles. While transiting through the fluid, pressure waves are induced in the fluid by one or more transducers. A particular configuration of the pressure waves (i.e., a specific waveform) is used to facilitate each piezoid particle being acted upon by one pressure wave at a time. An external static electric field is applied across the fluid. Impingement of the pressure waves on the piezoid particles causes the inducement of a piezoelectric field in each particle. The inducement of the piezoelectric field in the particles by the passing pressure waves causes the particles to move to align the induced piezoelectric field with the external static electric field applied across the fluid. The series of pressure waves causes the particles to rotate and/or translate towards an alignment with the applied static electric field. Each wave interacting with a particle may cause it to rotate and/or translate closer to proper alignment (to the extent that the particle is not already in a desired orientation); that is, alignment with the applied electric field. The piezoid particles then settle at the bottom of the chamber and form a bed of aligned piezoid particles. This piezoid bed may be used in a working chamber for deionization of a working fluid.

An exemplary embodiment includes a system having a deionization chamber containing a bed of piezoid particles and having a fluid inlet and a fluid outlet; a fluid input valve fluid coupled to the fluid inlet that allows a working fluid into the deionization chamber; an outlet valve fluidly coupled to the fluid outlet for exhausting the working fluid during flushing of the piezoid bed; and a deionized fluid outlet valve fluidly coupled to the fluid outlet for exhausting deionized working fluid from the deionization chamber.

Another exemplary embodiment includes a deionization chamber having a piezoid bed with a plurality of piezoid particles; a means for applying a uniaxial compressive force to the piezoid bed sufficient to induce a piezoelectric field in each piezoid particle; an inlet for admitting a working fluid; and an outlet for exhausting the working fluid after the working fluid has passed through the piezoid bed.

Another exemplary embodiment includes a method having the steps of applying a force to a piezoid bed in a chamber sufficient to induce a piezoelectric field in each of a plurality of piezoid particles comprising the piezoid bed resulting in a plurality of piezoelectric fields; allowing a working fluid to enter the chamber through an inlet; allowing the working fluid to flow through the piezoid bed, during the inducement of the piezoelectric fields, wherein such flow creates a deionized or partially deionized working fluid; exhausting the working fluid through to an outlet; measuring a conductivity of the working fluid at the outlet; upon the working fluid conductivity reaching a threshold, removing the force; purging the deionization module using the working fluid following removal of the force; measuring the conductivity of the working fluid at the outlet; and reapplying the force upon the conductivity reaching a second threshold.

Another exemplary embodiment includes a method having the steps of applying a force to a piezoid bed in a chamber sufficient to induce a piezoelectric field in each of a plurality of piezoid particles comprising the piezoid bed resulting in a plurality of piezoelectric fields; commencing a first timed interval; allowing a working fluid to enter the chamber through an inlet; allowing the working fluid to flow through the piezoid bed, during the inducement of the piezoelectric fields, wherein such flow creates a deionized or partially deionized working fluid; exhausting the working fluid through to an outlet; upon expiration of the first timed interval, removing the force; commencing a second timed interval upon removal of the force; purging the deionization module using the working fluid following removal of the force; and upon expiration of the second timed interval, reapplying the force.

Another exemplary embodiment includes a system having a piezoid, a plurality of piezoids, or a piezoid bed and a working fluid including charged particles, ions, and/or ionic complexes.

Another exemplary embodiment includes a method for removing charged particles, ions, and/or ionic complexes from a working fluid having the steps of applying a working fluid, including charged particles, ions, and/or ionic complexes, to a piezoid, a plurality of piezoids, or a piezoid bed; applying a force to the piezoid, plurality of piezoids, or piezoid bed to induce a piezoelectric effect; and removing charged particles, ions, and/or ionic complexes from said working fluid through applying the working fluid to the piezoid, plurality of piezoids, or piezoid bed.

These and aspects of the exemplary embodiments will become apparent from the following detailed description, taken in conjunction with the accompanying drawings, illustrating by way of example the principles of the various exemplary embodiments.

### DESCRIPTION OF THE FIGURES

FIG. 1 depicts ions in an aqueous solution.

FIG. 2A depicts a photomicrograph of monocrystalline quartz particles.

FIG. 2B depicts an example of the piezoelectric effect in a piezoid.

FIG. 3 depicts fluid flow through a piezoid bed.

FIG. 4 depicts a piezoid bed with non-uniform grain sizes according to exemplary embodiments.

FIG. 5 depicts a piezoid deionization system according to exemplary embodiments.

FIG. 6A depicts a top view of a deionization chamber according to exemplary embodiments.

FIG. 6B depicts a side view of a deionization chamber according to exemplary embodiments.

FIG. 6C depicts a perspective view of a deionization chamber according to exemplary embodiments.

FIG. 7A depicts a cut-away view of a deionization chamber according to exemplary embodiments.

FIG. 7B depicts a cut-away perspective view of a deionization chamber according to exemplary embodiments.

FIG. 8 depicts a table of components of a deionization chamber according to exemplary embodiments.

FIG. 9A depicts a top view of an upper pressure plate of a deionization chamber according to exemplary embodiments.

FIG. 9B depicts a cross-sectional view of an upper pressure plate of a deionization chamber according to exemplary embodiments.

FIG. 9C depicts a partial view of FIG. 9B.

FIG. 9D depicts a partial view of FIG. 9C.

FIG. 10A depicts a top view of a bottom plate of a deionization chamber according to exemplary embodiments.

FIG. 10B depicts a cross-sectional view of a bottom plate of a deionization chamber according to exemplary embodiments.

FIG. 10C depicts a partial view of FIG. 10B.

FIG. 11A depicts a top view of a pressure head of a deionization chamber according to exemplary embodiments.

FIG. 11B depicts a cross-sectional view of a pressure head of a deionization chamber according to exemplary embodiments.

FIG. 11C depicts a perspective view of a pressure head of a deionization chamber according to exemplary embodiments.

FIG. 12A depicts a top view of a piston of a deionization chamber according to exemplary embodiments.

FIG. 12B depicts a side view of a piston of a deionization chamber according to exemplary embodiments.

FIG. 12C depicts a partial view of FIG. 12B.

FIG. 13A depicts a top view of a drain plate of a deionization chamber according to exemplary embodiments.

FIG. 13B depicts a cross-sectional view of a drain plate of a deionization chamber according to exemplary embodiments.

FIG. 14A depicts an end view of thrust rod of a deionization chamber according to exemplary embodiments.

FIG. 14B depicts a side view of a thrust rod of a deionization chamber according to exemplary embodiments.

FIG. 14C depicts a partial view of FIG. 14B depicting details of the thread of the thrust rod according to exemplary embodiments.

FIG. 15A depicts a top view of a sintered filter disk of a deionization chamber according to exemplary embodiments.

FIG. 15B depicts a side view of a sintered filter disk of a deionization chamber according to exemplary embodiments.

FIG. 16 depicts a flow chart of an exemplary method.

FIG. 17 depicts a flow chart of an exemplary method of using a piezoelectric deionization system.

FIG. 18 depicts a flow chart of another exemplary method of using a piezoelectric deionization system.

### DETAILED DESCRIPTION OF THE VARIOUS EMBODIMENTS

### Overview

Exemplary embodiments include passing a working fluid through a piezoid bed in which a plurality of piezoelectric fields are generated (that is, each piezoid in the bed generates a piezoelectric field). The electric field is induced in the piezoid particles that make up the piezoid bed through an application of a force to the piezoid bed. The working fluid can be liquid or gas or combinations thereof. The piezoid bed consists of a plurality of piezoid particles and is contained in a chamber or vessel. The piezoid particles may aligned or unaligned.

According to exemplary embodiments, the piezoid bed is contained in a containment vessel. The piezoid bed may be contained in a sleeve which can be used to transfer the piezoid bed to/from the containment vessel. Compressive force (such as pressure) is applied to the piezoid bed. The piezoid bed, according to exemplary embodiments, may be made of monocrystalline quartz particles. Various embodiments may use other piezoids, such as ceramics or synthetic piezoids. The piezoid may be arranged in a bed or may be otherwise arranged. According to exemplary embodiments, the containment vessel is a chamber or cylinder. The force can be applied through mechanical methods. For example, hydraulics can used to apply the pressure. However, the pressure can be applied in other manners such as by using mechanical and/or electro-mechanical methods. In various embodiments, a piston or a flat, confining plate can be used to apply the pressure.

The working fluid is input to the chamber and allowed to flow through or over the piezoid bed while pressure is applied. Because of the induced piezoelectric effect in the piezoids of the piezoid bed, ions, ionic complexes, and/or charged particles in the working fluid are attracted to the piezoids. The working fluid, once it passes through the piezoid bed, is deionized, either all or in part, through the removal of the charged particles, ions, and/or ionic complexes. The working fluid can be a liquid or gas or combinations thereof. The working fluid can be passed through the chamber multiple times or through other chambers to further remove any ions or ionic complexes remaining. Exemplary embodiments may be used to desalinate water through removal of salts contained in the water. For example, the working fluid may be brine. Various embodiments may use other working fluids. For example, the working fluid may be a gas containing charged particles. For example, exhaust emanating from combustion processes at power plants may contain charged particles that can be removed by a piezoelectric deionizer according to various embodiments.

The piezoid bed may be flushed or purged after removal of the ions, ionic complexes, and/or charged particles from the working fluid. The working fluid may be used to flush the piezoid bed. During flushing, the pressure is removed from the piezoid bed, which releases the ions, ionic complexes, and/or charged particles. The flushing fluid may be the same as the working fluid. In various embodiments, another fluid may be used to flush/purge the piezoid bed. That is, the other fluid for flushing may be different from the working fluid. The flushing fluid may be in the same state as the working fluid or may be in a different state. For example, the working fluid may be a liquid and the flushing fluid may be a liquid; the working fluid may be a gas and the flushing fluid may be a liquid or vice versa.

### Current Desalination Technologies

Desalination technologies take advantage of the ionic nature and the ligand-like structures to effect separation of salts from water. The various techniques used for desalination can be grouped into two categories, physical and chemical. Physical desalination processes include evaporation, filtration, electrostatic and electrodynamic separation. Chemical desalination processes include precipitation, ion exchange, and chelation.

### Advantages of Exemplary Embodiments

A piezoelectric deionization system using piezoelectric effect for deionization offers several economic advantages over systems currently used to desalinate sea water and salt water brines. The system may have a simplicity of design resulting in low capital and operating costs. For example, the system does not require chemical reagents to form insoluble precipitates, recharge ion exchange resins, or refurbish membranes. A system according to exemplary embodiments is designed to use monocrystalline quartz, the most abundant mineral on earth. The very low cost of this commodity allows exemplary embodiments to be used in economically stressed areas. Quartz possesses a very high compressive strength, has excellent piezo electric properties, is environmentally benign, and has a virtually unlimited lifetime. Importantly, when used with water as the working fluid, it contributes no measurable contamination to the fresh water produced by the system.

A piezoelectric deionization system, according to exemplary embodiments, is a low energy system. The very high compressive strength of the piezoid material results in very little movement of the compression piston, and because work (or energy) is defined as a force applied over a distance, the energy is very low. The hydraulic pressures acting over the face of the piston results in an extremely small movement of the piezoids. Thus, the amount of energy used during any compression cycle is very low. Piezoid materials have a long life, almost eliminating the need for replacement of the piezoids of the piezoid bed.

Exemplary embodiments, unlike reverse osmosis systems, does not require high pressure pumps to move fluid through the system. Though high pressure is applied to the piezoid bed, the pore pressure required to facilitate fluid movement through the system is controlled only by the permeability of the piezoid bed and the desired flowrate.

Furthermore, a piezoelectric deionization system, unlike evaporative systems, is not influenced by solar influx or humidity. Exemplary embodiments can be deployed to any location that has a source of fluid that requires removal of charged particles, ions, and/or ionic complexes from solution.

Furthermore, exemplary embodiments can be scaled to any size with no fundamental changes in design.

### Ions in Solution

All salts and most heavy metals are present in water as ions or ionic complexes. Ions are atoms which are not electrically neutral but carry an electronic charge. Common table salt, the most common salt in sea water, whose chemical composition is written as NaCl, is composed of two types of atoms, sodium and chlorine. When NaCl dissolves in water it splits into Na⁺ and Cl⁻ ions. The positive sign on the sodium symbol (Na⁺) indicates that the sodium ion carries an excess positive charge. The negative sign on the chlorine symbol (Cl⁻) indicates that the chlorine carries an excess negative charge.

Another mineral that dissolves in water is limestone, chemically referred to as calcium carbonate CaCO₃. As with common table salt, calcium carbonate separates in water into two smaller components, each of which forms a ligand like structure with surrounding water molecules. The smaller components are the calcium ion (Ca⁺⁺) and the carbonate complex or radical (CO₃⁻⁻). Calcium carbonate is a principal constituent in hard water, and can be removed by desalination.

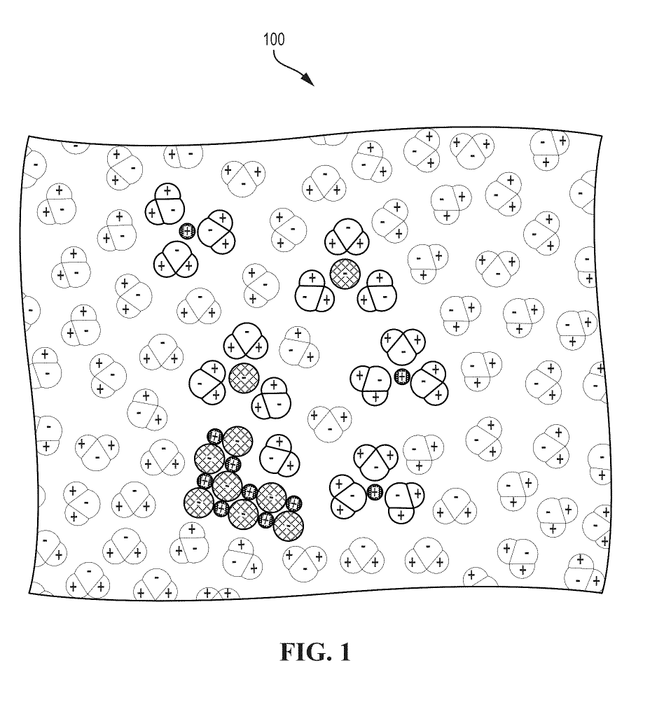

The Na⁺ or Ca⁺⁺, and the Cl⁻ or CO₃⁻⁻ do not simply recombine into salt molecules. This is because water, though electrically neutral as a molecule, has an unbalanced charge. One end of the water molecule has a slightly negative charge while two other ends of the molecule have a slightly positive charge. Any free Na⁺ or Ca⁺⁺ ion in water is surrounded by a cloud of water molecules each oriented in such a way as to position the negative end of the water molecule as close as possible to the Na⁺ or Ca⁺⁺ ion. In a similar manner, any free Cl⁻ ion or CO₃⁻⁻ radical is surrounded by a cloud of water molecules each oriented in such a way as to position the positive ends of the water molecules as close as possible to the Cl⁻ ion or CO₃⁻⁻ radical. The clouds of water molecules and their associated ions or radicals are ligand-like structures and prevent the ions from recombining by maintaining a significant separation between them. Element 100 of FIG. 1 depicts ions in an aqueous solution and depicts the unbalanced charge of water as described above.

It should be appreciated that while water was used as an example in the preceding section, this is meant to be exemplary and non-limiting as other fluids can carry ions, ionic complexes, and/or charged particles.

### Piezoelectric Effect and Piezoid Bed

Certain materials have unit crystal lattice structures that, when no external forces are applied, have a symmetric charge distribution. When external forces are applied to these same materials, a charge asymmetry develops. This charge asymmetry manifests itself as an electric field emanating from the material.

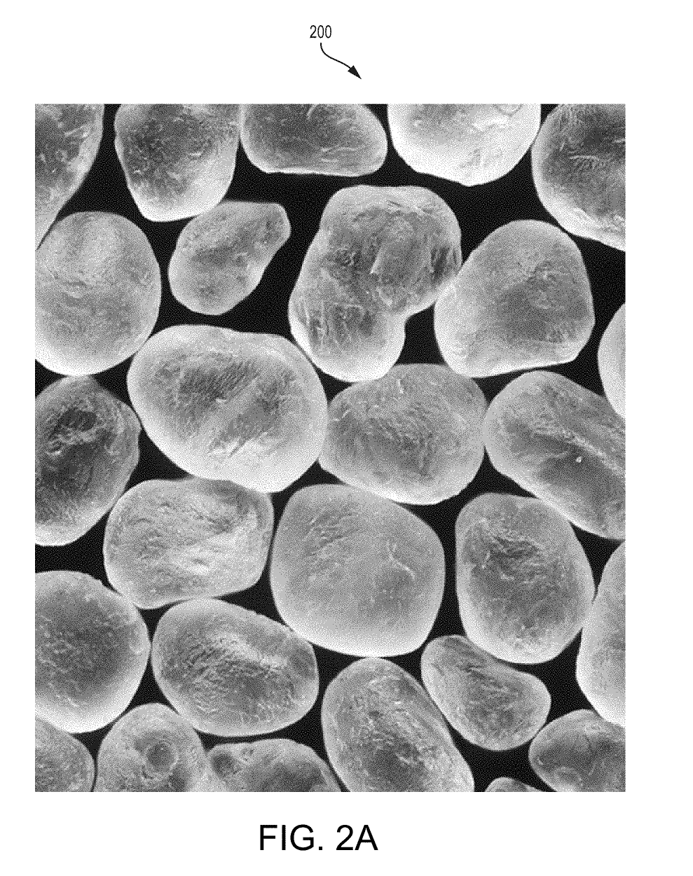

There are many substances, both natural and synthetic, that exhibit the piezoelectric effect. A natural piezoid is quartz. Quartz is the most common mineral on the surface of the Earth, and occurs in igneous, metamorphic and sedimentary rocks. Quartz has a framework structure of SiO₄ tetrahedra linked by shared corner oxygens. At atmospheric pressure, alpha-quartz transforms to beta-quartz at 573° C. by small displacements of the linked SiO₄ tetrahedra—a displacement phase transition. FIG. 2A depicts a photomicrograph 200 of monocrystalline quartz particles.

If grains of a piezoid, such as quartz as depicted in FIG. 2A, are compacted and confined in such a way that a uniaxial force may be applied, a certain percentage of the grains will be aligned in such a way that the applied force will generate electric fields of sufficient strength to attract free ions passing through the bed of particles.

FIG. 2B depicts an example 250 of the piezoelectric effect in a piezoid. In FIG. 2B, the image 252 at the left represents a grain of quartz without the application of an external force. When no force is applied, no electric field is produced. The image 254 in the center of FIG. 2B illustrates the electric field generated when a tensile force is applied. The image 256 at the right in FIG. 2B illustrates the electric field produced when a compressive force is applied. Note that when the force changes from tension to compression, the direction of the electric field is reversed. The strength of the electric field emanating from a quartz particle can be very high. A properly oriented quartz particle exposed to an applied uniaxial pressure of 1,000 pounds per square inch (psi) will generate an electric field of approximately 334,000 Volts per meter, a very strong field. In exemplary embodiments, the applied force used in the system must not cause the orthogonal pressure force to exceed the bursting strength of the containment vessel nor exceed the compressive strength of the piezoid material.

### Piezoid Bed

According to exemplary embodiments, monocrystalline quartz may be used as the piezoid to make up the piezoid bed. In various embodiments, other piezoids, either natural or manmade may be used. For example, ceramic or plastic piezoids may be used. A combination of different piezoids may be used.

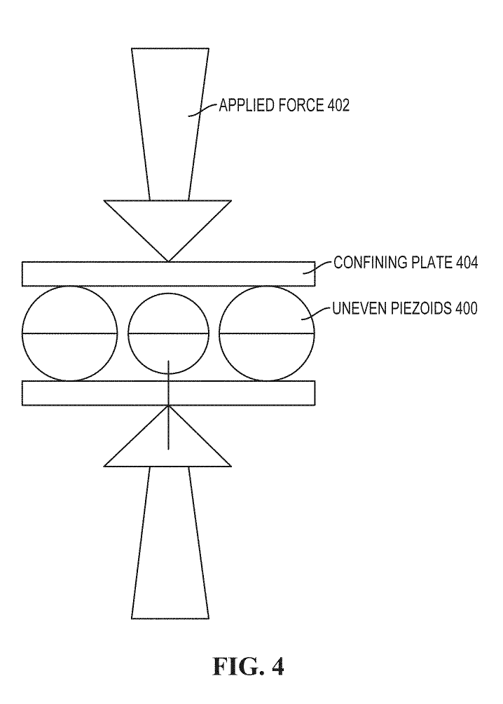

The piezoids may be inserted into a chamber to form the piezoid bed. For example, a piezoid bed of aligned piezoids may be used. In various embodiments, the piezoid particles may be introduced directly into a working chamber, such as that of FIG. 5. The piezoid particles may be arranged in different manners in the chamber to form the piezoid bed. In exemplary embodiments, the piezoids may be well compacted into the bed. For example, vibratory compaction may be used to settle the piezoid grains into the bed. This compaction may be performed following introduction of the piezoid particles to the chamber. The chamber may be completely or almost completely filled such that travel of the member applying the compressive force is small. For example, in a system using a piston to apply the force, the piston travel to place a required amount of force on the piezoid bed may be on the order of few hundredths or thousandths of an inch. It should be appreciated that the amount of movement is a function of the compressive strength of the piezoid material. For example, quartz has a very high compressive strength while plastic piezoids may have a very low compressive strength. The depth of the piezoid bed may also effect the compressive movement. For example, a very deep bed may require more compressive movement than a comparatively shallow bed.

A certain grain size may be desired to ensure operation of the system in an efficient manner. The grain size may be within a particular range, with an upper and lower threshold being desired. In various embodiments, the cumulative surface area is important and the efficiency of the system may increase with surface area. However, the permeability of the piezoid bed may decrease as the grain size decreases. Therefore, a balance must be struck between the efficiency and permeability with respect to grain size. Grain sizes ranging from 10 mesh to greater than 100 mesh may be used. According to exemplary embodiments, 20-80 mesh may be a preferred grain size.

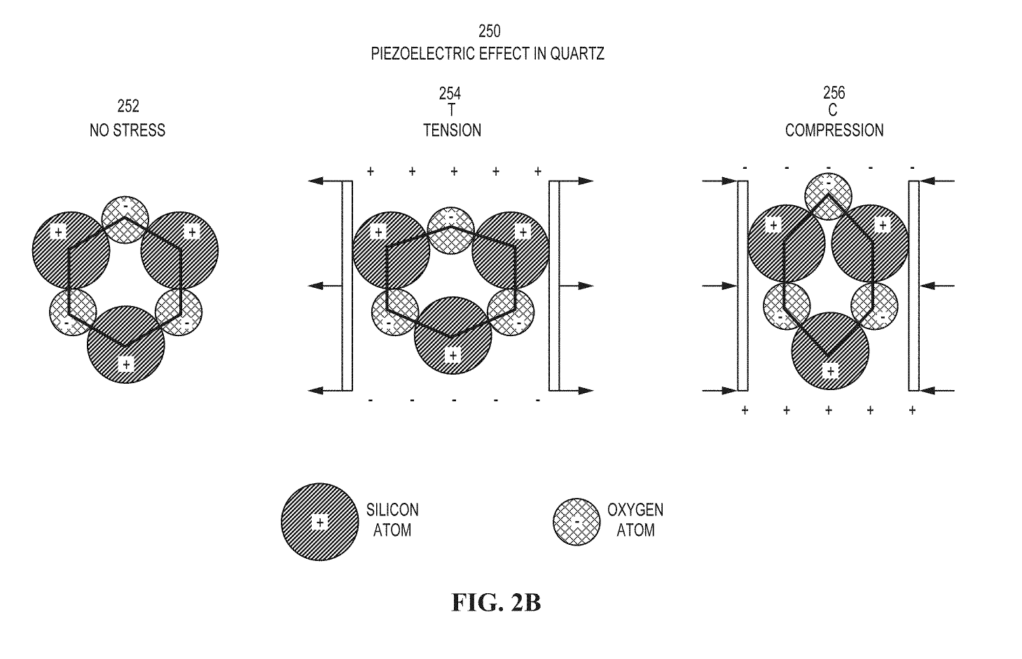

FIG. 3 depicts a bed 300 of uniform piezoid grains confined between two horizontal plates. The vertical arrow represents the compressive force 306 applied to the grains through the two horizontal plates 302. The horizontal arrows 304 in FIG. 3 represent fluid containing ions, charged particles, ions or ionic complexes. The charged components will be attracted to points of opposite charge on the piezoid grains. The fluid (e.g., gas or liquid) flowing through the piezoid bed will pass through unimpeded while the charged components contained in the fluid will be retained as they are attracted to the charged piezoid grains. The charged particles, ions, and/or ionic complexes, are thus separated from the fluid carrying them. The amount of ions and ionic complexes separated from the fluid is a stochastic process. For example, for a fluid passing through a piezoid bed under pressure, in various embodiments, a certain percentage of the ions and ionic complexes contained the fluid may be separated. Multiple passes through one or more piezoid beds may be required to remove all or almost all of the ions and ionic complexes.

With uniform grains, pressure can be applied by a uniaxial force pressing down on a confining plate. Each of the piezoid grains will experience the same applied force over the same area. The uniform orientation ensures that each piezoid grain will generate an electric field of maximum intensity.

Once the pressure on the grains is released, the piezoid grains lose their electric fields and release the ions, ionic complexes and charged particles which were attracted to them. Because the attraction between the ions and piezoid grains is electrostatic, it is important that the flow rate of the fluid through the system be low to prevent washing the charged particles, ions or ionic complexes out of the system.

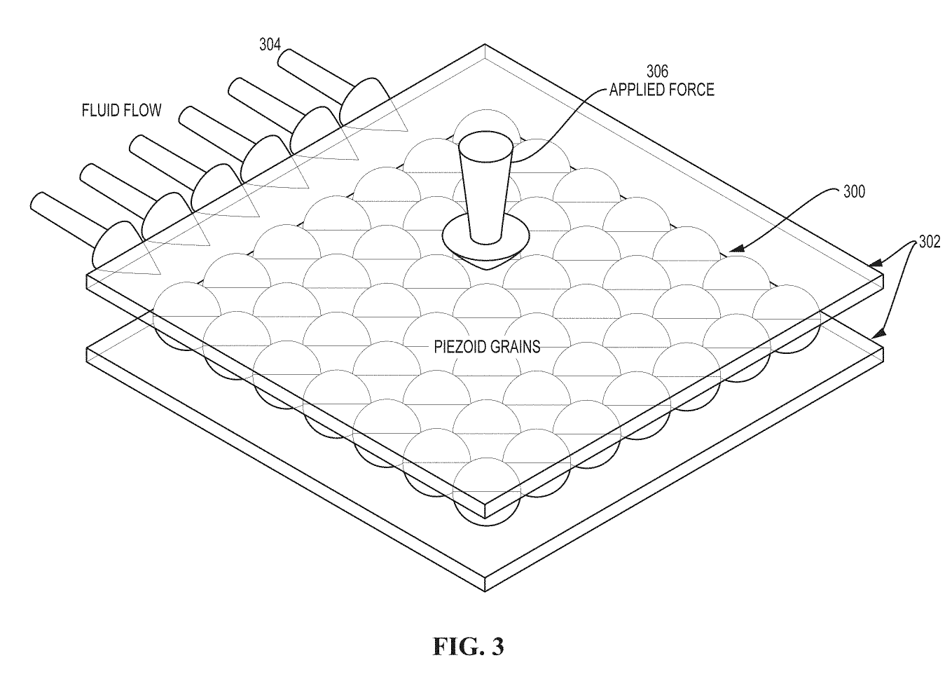

In various embodiments, the piezoids may vary in size, shape, and orientation. For example, the sizes, shapes, and orientations of the piezoids may be random and non-uniform. The random nature of the sizes may make the application of a uniform pressure to each piezoid grain more difficult. For example, large grains confined between two plates can contact the plates before the smaller grains. FIG. 4 depicts the effect of force 402 when applied to piezoids 400 of unequal size between confining plates 404. The piezoid in the center does not experience any applied force, while the larger particles on either side feel the applied force. This means that the central piezoid does not generate an electric field.

According to exemplary embodiments, to account for this size variation in piezoid particles, a layer of soft material may be inserted or interposed between the rigid plate(s) and the piezoids. For example, the material may be placed on the underside of the piston to contact the grains during application of the compressive force. The material in this interposing layer must have an elastic limit that allows the material to function in the plastic regime when exposed to the applied force. For example, a soft metal (such as silver, tin, or copper) or plastic or elastomer or other material may be used. The interposing layer may be porous or sintered to allow fluid flow through it. The material may possess a low elastic limit to allow entry into the plastic regime under the applied pressure. In this manner, the material may deform and maintain its deformation throughout the use of the system. This ensures a uniform application of force to the piezoid bed over time.

In various embodiments, the piezoid grains may be ground into uniform spherical grains prior to use in the piezoid bed. If the grains are so ground, no interposing layer is required. To generate the electric field in a piezoid particle or group of piezoid particles, a uniaxial force is applied to the material.

### Piezoid Deionization System

FIG. 5 depicts a piezoid desalination system according to exemplary embodiments. The system 500 may have the following components: a deionization chamber or cylinder 502, a piezoid, a plurality of piezoids, or a piezoid bed 504 contained in the deionization chamber, a fluid input valve 506, an outlet valve or brine outlet valve 508, a deionized fluid outlet valve 510, a piston 512 in the deionization chamber, a hydraulic pressure source and modulator 514, and a working fluid. The working fluid is input through a fluid input 516. The deionization chamber 502 has an output 518. Located proximate the output 518 may be a conductivity sensor 520. It should be appreciated that the arrangement and configuration of the various components of the system 500 is exemplary and meant to be non-limiting, as a variety of other arrangements and configurations are possible.

As depicted in the system 500, each valve may be motor operated (522) and remote controlled manually or automatically by a computer or a computer controlled device (not shown). In various embodiments, one or more of the valves may be directly manually controlled.

The system 500 has a single deionization chamber 502. In various embodiments, multiple deionization chambers may be used in series and/or parallel. The working fluid may be passed through these multiple chambers allowing the working fluid to pass through a piezoid bed multiple times to remove as many ions and ionic complexes from the working fluid. Such multiple passes may be required to ensure that the working fluid reaches a desired end state for a particular use. For example, it may be desired to produce potable water which must contain a particular level of ions and ionic complexes. The system may be used in a batch or continuous processing manner. For example, the working fluid may be passed through the same piezoid bed multiple times. A combination of batch and continuous processing may be used. In other embodiments, the working fluid may pass through a different piezoid bed each time.

### Deionization Chamber

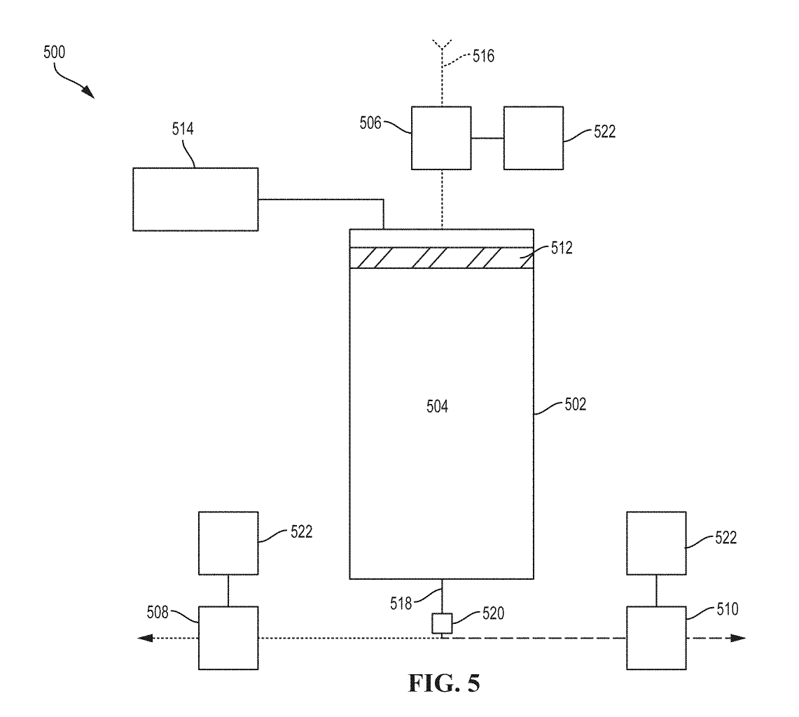

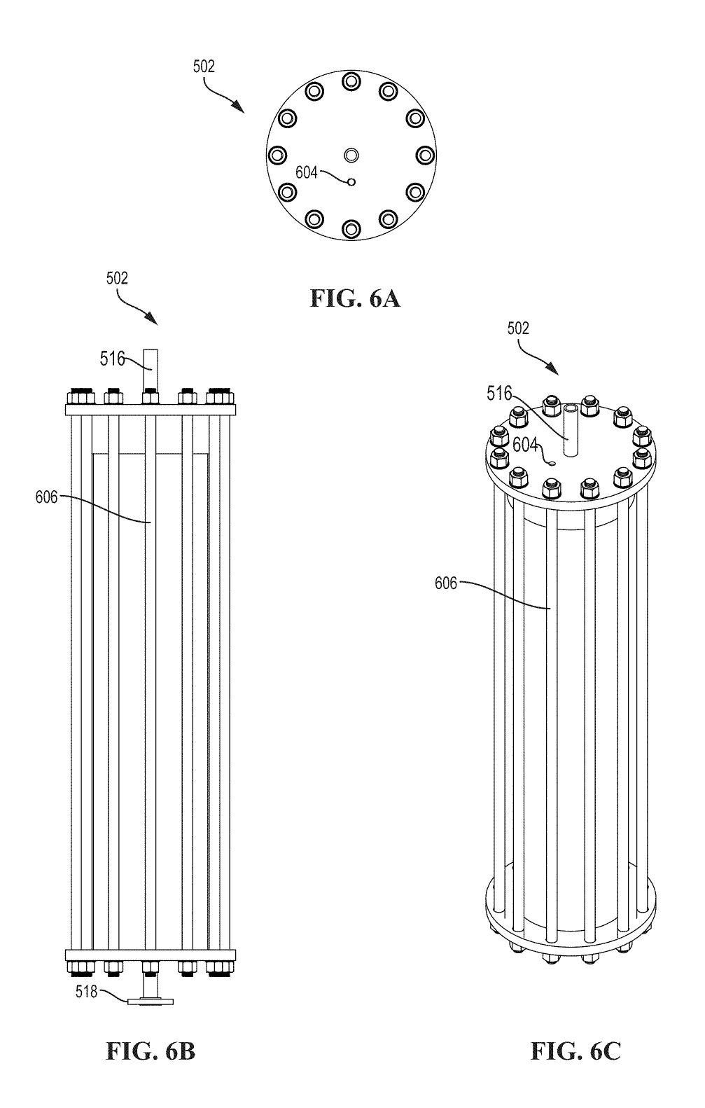

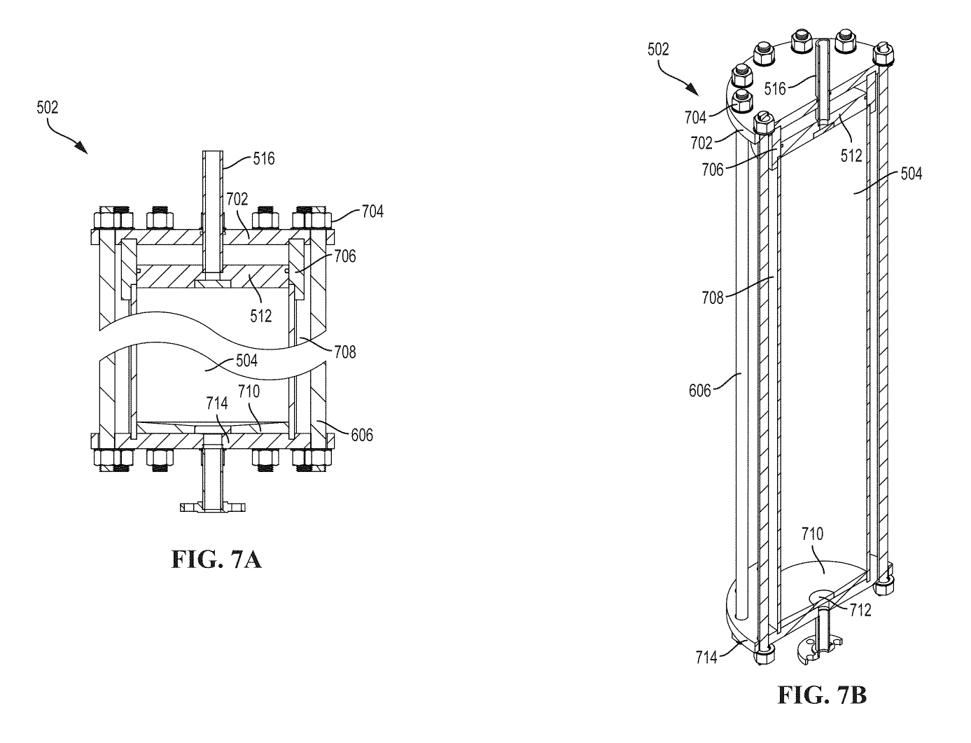

As described above, the piezoid, piezoid particles, or piezoid bed 504 may be contained in a deionization chamber 502. According to exemplary embodiments, the chamber may be a cylinder. The piezoid bed 504 may consist of a plurality of particles as described above. The piezoid bed 504 may consist of aligned particles. The piezoid bed 504 may be contained in a sleeve. FIGS. 6A-C and 7A-B depict a deionization chamber 502 according to exemplary embodiments. FIG. 8 is a table providing a listing of the various components of the deionization chamber, along with exemplary dimensions and materials. It should be appreciated that the chamber may have other shapes and sizes in various embodiments, and the use of the depicted cylinder in FIGS. 6A, B, and C and FIGS. 7A and B, as well as the components in FIG. 8, is meant to be exemplary and non-limiting. The deionization chamber 502 may accept the sleeve, if used, through the bottom portion of the chamber. The deionization chamber 502 has an input 516 for inputting the working fluid. In various embodiments, the working fluid may be brine (that is, the working fluid may be salt water or the like). Other working fluids may be used that require removal of charged particles, ions, and/or ionic complexes from solution. For example, exemplary embodiments may use gas as the working fluid, such as gasses containing charged particles, ions or ionic complexes. For example, charged particles in exhaust emanating from combustion processes at power plants could be removed by a piezoelectric deionizer according to various embodiments.

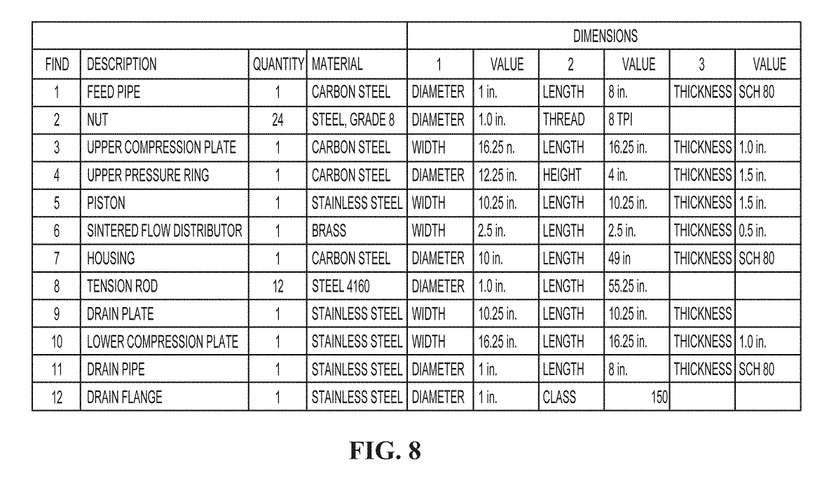

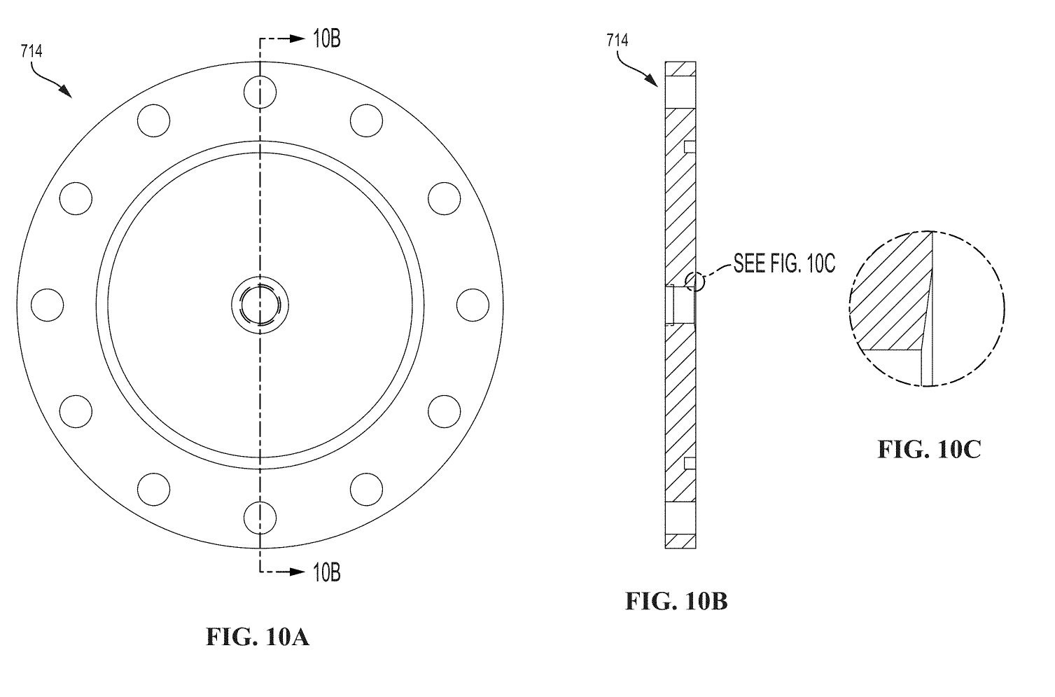

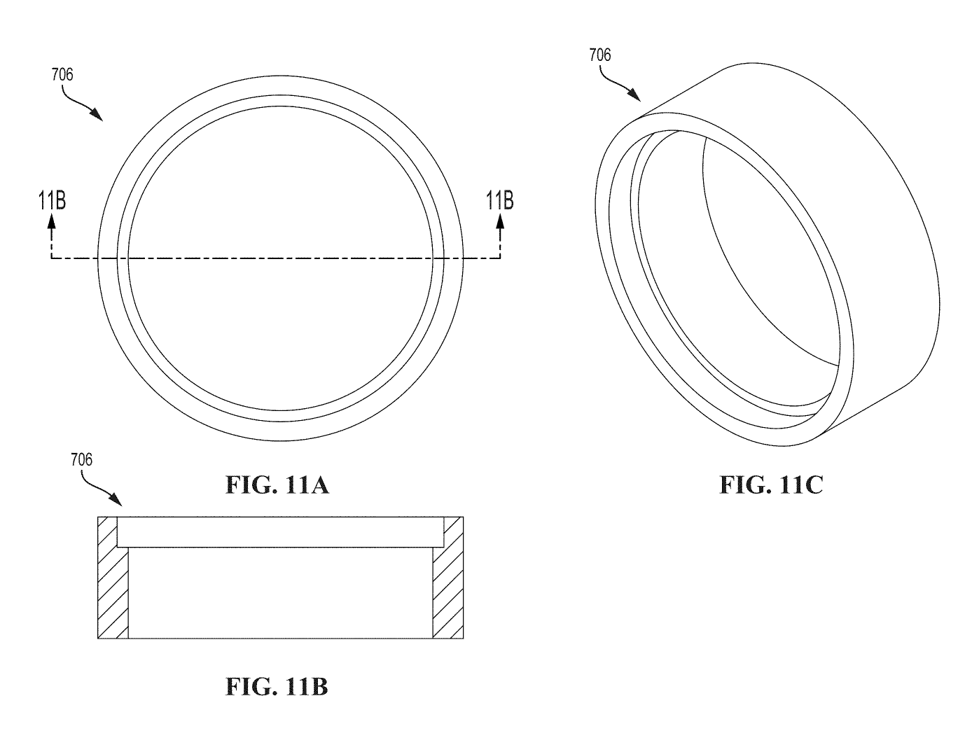

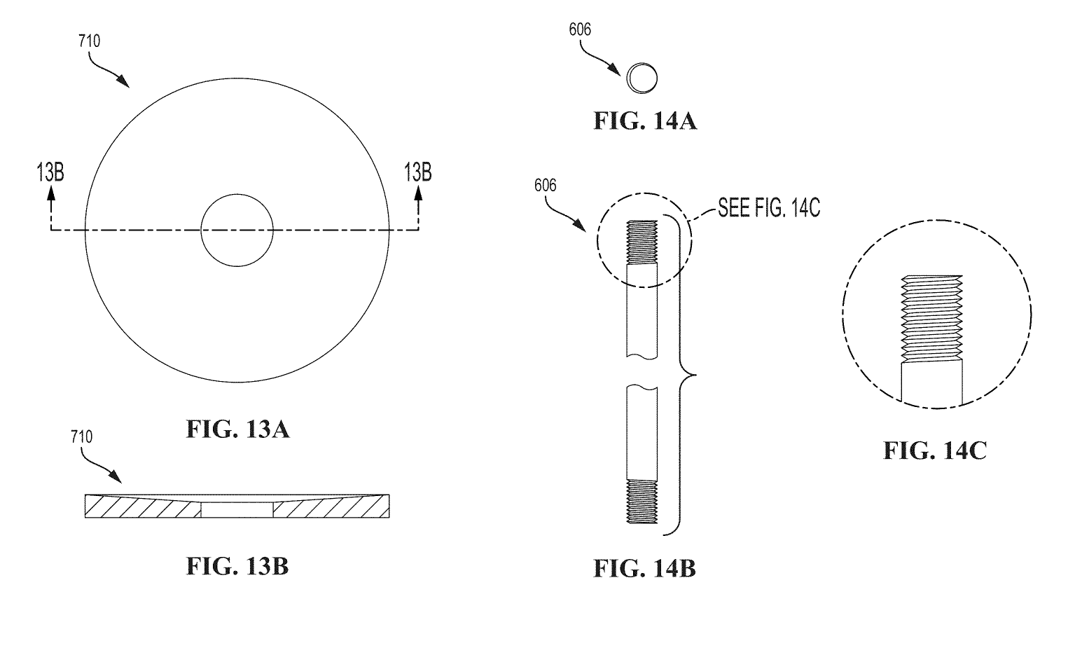

The deionization chamber 502 has a hydraulic port 604 to which the hydraulic source/modulator 514 is fluidly coupled. The deionization chamber 502 is surrounded by a series of thrust rods 606. The thrust rods 606 provide for absorption and transfer to cylinder stress imparted during operation of the deionization chamber 502. The thrust rods 606 are coupled to a pressure cap 702. Each thrust rod 606 is secured by a hex nut 704. Details of the thrust rod 606 are depicted in FIGS. 14A-C. Details of the pressure cap or upper pressure (or compression) plate 702 are depicted in FIGS. 9A-D. The piston 512 is confined within a pressure ring or head 706. Details of the piston 512 are depicted in FIGS. 12A-C and details of the pressure head 706 are depicted in FIGS. 11A-C. The piezoid, piezoid particles, or piezoid bed 504 is confined within a containment vessel 708.

The use of a hydraulic piston is exemplary and non-limiting as other structures can be used to apply the required force to the piezoid bed in the chamber. For example, mechanical or electromechanical actuation can be used to apply the force. A confining plate can be used to apply the force.

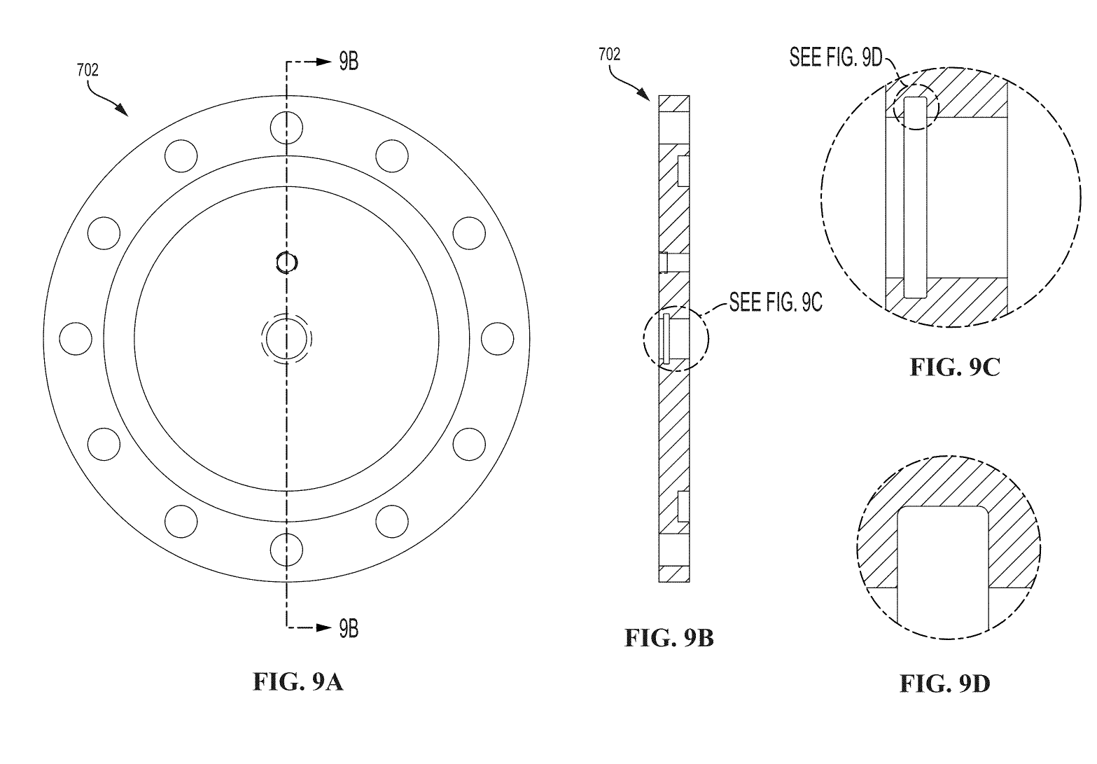

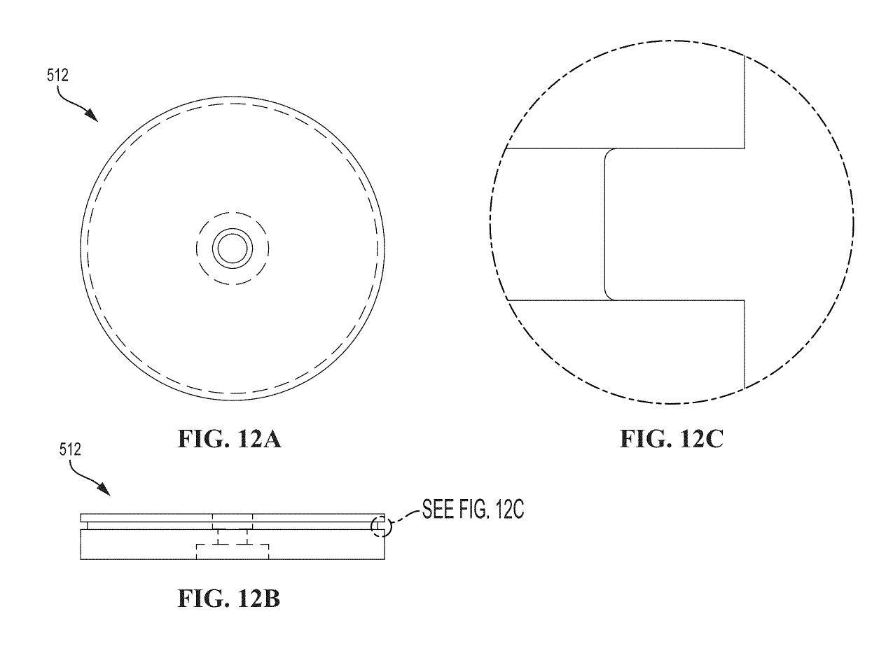

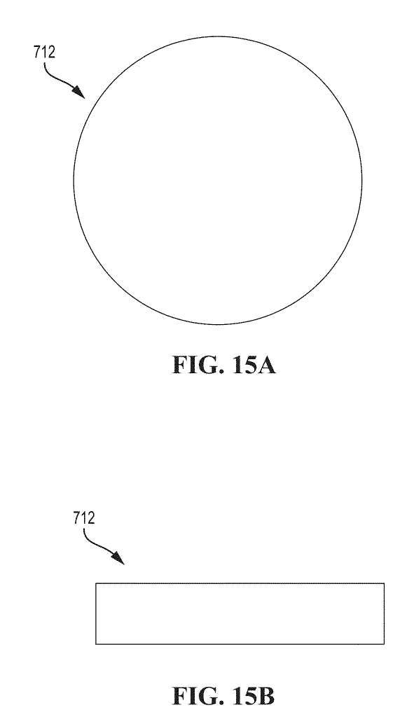

Located at the lower portion of the containment vessel 708 is a drain plate 710 and a sintered filter 712. The lower portion of the deionization chamber is contained by a lower pressure plate 714. Details of the bottom or lower pressure (or compression) plate 714 are depicted in FIGS. 10A-C. Details of the drain plate 710 are depicted in FIGS. 13. A second sintered filter (not shown) may be located between the piston and the piezoid, piezoid particles, or piezoid bed 504, at the upper portion of the containment vessel 708. Details of the sintered filer 712 are depicted in FIGS. 15A and B. In various embodiments, an interposing, plastically deformable material may be used between the piston and the piezoid bed (not shown). This material may be located between the second sintered filter and the piezoid bed.

The piezoid (piezoid particles) 504 may be placed into the deionization chamber and be mechanically settled in order to be well compacted to form the piezoid bed. A piston may be located at the upper part of the chamber. The piston may be used to apply a compressive force to the piezoid bed. The cylinder may be constructed with a particular aspect ratio. The aspect ratio may be optimized to minimize generation of lateral forces during the compression of the piezoid bed. The aspect ratio may be based on the internal angle of friction of the compressed piezoids. For example, the cylinder may have an aspect ratio where it is wider than it is tall. The cylinder may be taller than it is wide. The aspect ratio may be a function of cost, the material used for the cylinder, and the application the cylinder is used for (i.e., what throughput of working fluid is required or desired). In various embodiments, thrust rods may be included around the circumference of the cylinder to absorb the stress resulting from the pressure application to the piezoid bed.

### Operation of Exemplary Embodiments

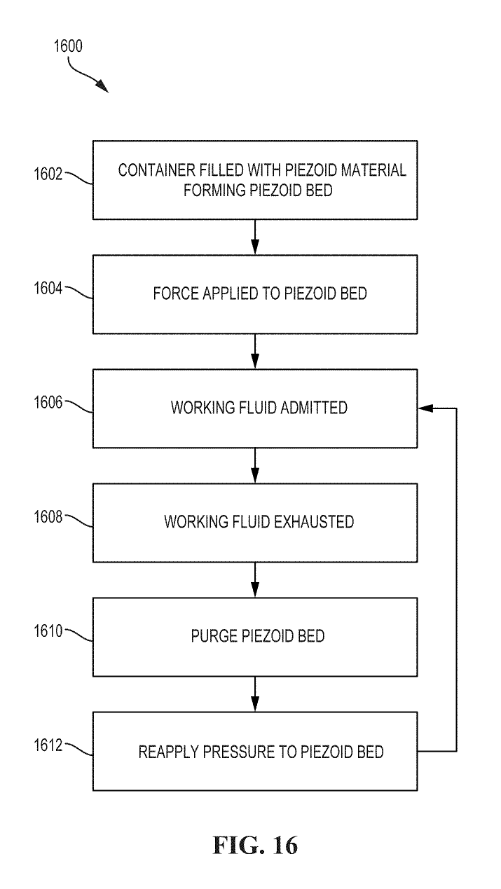

FIG. 16 depicts an exemplary method 1600. The method 1600 may be implemented using a system as described herein, such as the system 500 of FIG. 5. It should be appreciated that other system configurations may be used.

At 1602, a container is filled with piezoid particles. The piezoid particles may be arranged in a variety of manners. The piezoid particles may be natural or synthetic. The piezoid particles may be compacted and settled to form a bed. The container is then sealed in preparation for operation.

At 1604, a force is applied to the piezoid bed. This force or pressure is applied to induce a piezoelectric field or effect in the plurality of piezoid particles in the piezoid bed. Various mechanical and/or electro-mechanical methods may be used to apply the force. For example, a piston may be used to apply a uniaxial compressive force to the piezoid bed. In various embodiments, a mechanical or electro-mechanical actuator may be used to apply the force. The applied force causes properly oriented piezoids to generate electric fields. These fields will attract charged particles, ions, and/or ionic complexes from the working fluid flowing through the piezoid bed.

At 1606, a working fluid, for example, a liquid or a gas containing charged particles, ions, and/or ionic complexes, is admitted to the container through a fluid input valve. A volume of working fluid is admitted to fill the interstitial volume of the piezoid bed. The fluid input valve remains open during operation. The pressure remains applied to the piezoid bed.

At 1608, the working fluid is exhausted from the container. In exemplary embodiments, a deionized fluid outlet valve is open to exhaust the working fluid after it has passed through the piezoid bed. The pressure remains applied to the piezoid bed. As the working fluid passes through the piezoid bed, the charged particle, ion, and/or ionic content of the working fluid decreases. In various embodiments, the working fluid may be ported to another container for further deionization, the working fluid may be ported back to the input to the container, or the working fluid may be ported for use and/or storage.

At 1610, a purge of the piezoid bed is conducted. The piezoid bed requires flushing or purging to remove the charged particles, ions, and/or ionic complexes from the bed. After a certain volume of working fluid has passed through the piezoid bed, the piezoid particles may become saturated with removed charged particles, ions, and/or ionic complexes. The ability of the piezoid bed to remove such from the working fluid is thus decreased.

To flush the bed, the pressure is removed from the piezoid bed which eliminates the piezoelectric field. A flushing fluid is passed through the piezoid bed. The flushing fluid may be exhausted through an outlet valve that is different from the deionized fluid outlet valve. The deionized fluid outlet valve is closed. The flushing fluid may be the working fluid. In various embodiments, a different flushing fluid may be used. The flushing fluid flows through the bed and flushes the charged particles from the piezoid bed.

At 1612, upon completion of the purge, the force is reapplied to the piezoid bed causing a regeneration of the piezoelectric fields in the piezoid particles of the piezoid bed and the outlet valve is closed. The deionized fluid valve is then opened.

The purge cycle may be conducted at various intervals. The intervals may be based on time or other parameters. For example, measurements of certain properties of the working fluid being exhausted may be measured, such as conductivity. After a threshold is reached, the purge cycle may commence.

The cycle repeats at 1606 with the working fluid being admitted to the container to pass through the piezoid bed.

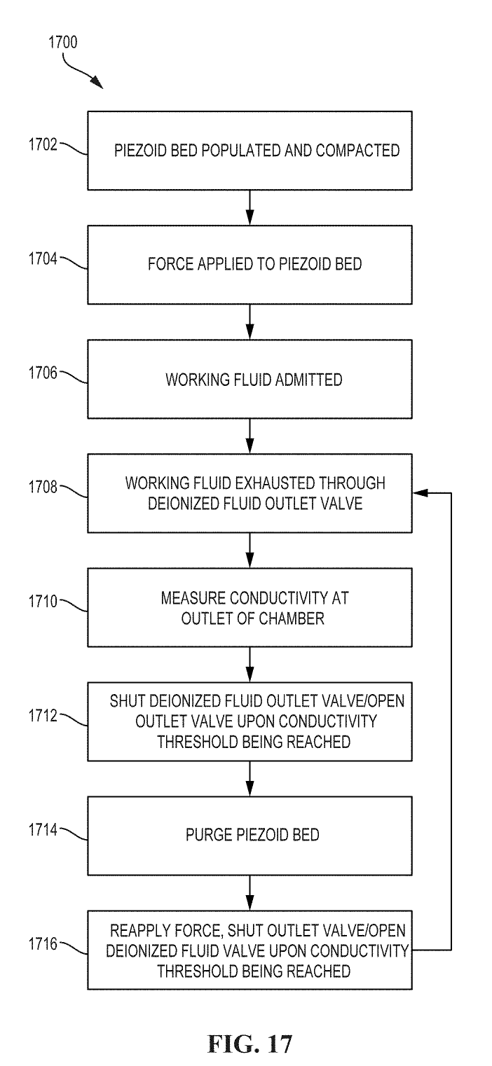

An exemplary cycle for a piezoid deionization system according to exemplary embodiments is described below. FIG. 17 depicts an exemplary method 1700. The method 1700 may be carried out using the system 500 of FIG. 5. The system may be cyclical in operation. For example, a pulsed cycle may be used.

At 1702, the deionization chamber is filled with piezoid grains to form a piezoid bed. The piezoid grains are compacted and settled. The deionization chamber is then sealed in preparation for operation. This is a prerequisite step. It should be appreciated that while this method is described using a piezoid bed as an exemplary embodiment, various embodiments may use different piezoid arrangements.

At 1704, a force is applied to the piezoid bed. For example, a piston applies a uniaxial compressive force or pressure to the piezoid bed. The piston may be hydraulically actuated. This force induces a piezoelectric field or effect in the plurality of piezoid particles in the piezoid bed. The applied force causes properly oriented piezoids to generate electric fields. The electric fields may be of significant strength. These fields will attract charged particles, ions, and/or ionic complexes from the working fluid flowing through the piezoid bed.

As noted above, the use of a hydraulic piston is meant to be exemplary. Other methods can be used to apply the required force to the piezoid bed. The methods can be mechanical and/or electromechanical. A combination of methods may be used. For example, a servo actuator may be used with a flat confining plate to apply the compressive force.

At 1706, a working fluid, for example, brine or a gas containing charged particles, ions, and/or ionic complexes, is admitted to the deionization chamber through the fluid input valve. A volume of working fluid is admitted to fill the interstitial volume of the piezoid bed. The fluid input valve remains open during operation of the deionization chamber. The pressure remains applied to the piezoid bed.

At 1708, the working fluid is output from the deionization chamber. The deionized fluid outlet valve is open to exhaust the working fluid after it has passed through the deionization chamber. As the working fluid passes through the piezoids, the charged particle, ionic, and/or ionic complex content of the working fluid thus decreases. The pressure remains applied to the piezoid bed.

At 1710, a conductivity sensor measures the conductivity of the working fluid at the outlet of the deionization chamber (before the deionized fluid outlet valve).

At 1712, once the measured conductivity reaches a certain threshold value, the deionized outlet valve is shut and an outlet valve is opened. The measured conductivity can provide an indication of the amount of charged particles, ions, and/or ionic complexes in the working fluid at the outlet. The measured conductivity remaining below a certain threshold provides an indication that the piezoid bed is removing charged particles, ions, and/or ionic complexes from the working fluid. The measured conductivity reaching (or exceeding) a threshold value is an indication that the piezoid bed is approaching or has reached saturation, such that it is not removing charged particles, ions, and/or ionic complexes from the working fluid.

At 1714, a purge of the piezoid bed is conducted. The piezoid bed requires flushing or purging to remove the charged particles, ions, and/or ionic complexes from the bed. To flush the bed, the pressure is removed from the piezoid bed which eliminates the piezoelectric field. With the outlet valve open, the working fluid flows through the bed and flushes the charged particles from the piezoid bed.

At 1716, the purge is completed. The measured conductivity provides an indication of when the piezoid bed has been flushed. During flushing, the conductivity will be high; once a certain volume of fluid has passed through the bed and the charged particles are removed, the conductivity of the working fluid at the outlet will drop. Force is reapplied to the piezoid bed, causing a regeneration of the piezoelectric field and the outlet valve is closed. The deionized fluid valve is then opened.

The cycle repeats at 1708.

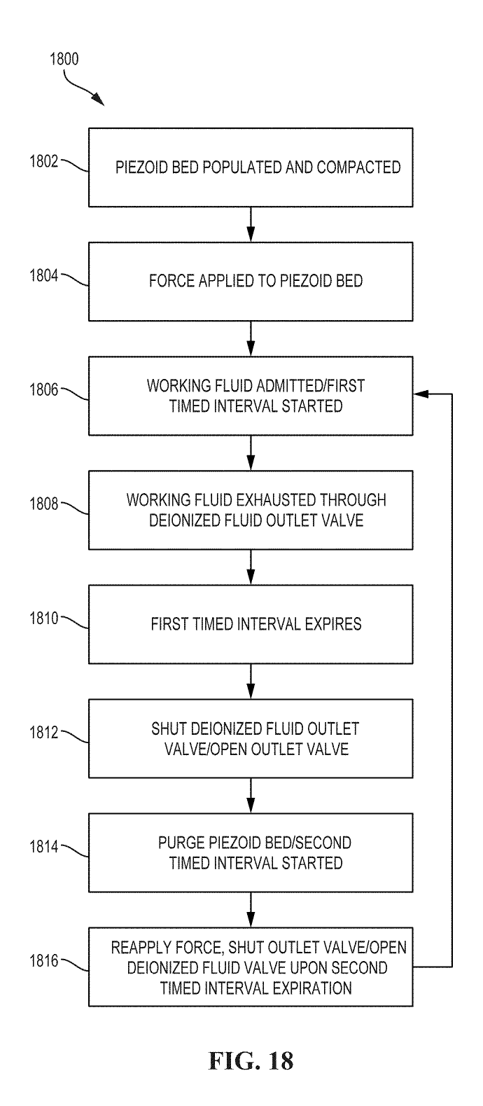

FIG. 18 depicts a second exemplary method 1800. The method 1800 may be carried out using the system 500 of FIG. 5. However, the system may lack a conductivity sensor and instead employ a timing system. The timing system would sequence the valves to flush the deionization chamber at regular intervals. For example, the timing system would cycle deionized fluid outlet valve and the brine outlet valve between open and shut on set intervals. This method may be used in application having a constant rate of flow and constant salinity in the brine. The system may be cyclical in operation. For example, a pulsed cycle may be used.

At 1802, the deionization chamber is filled with piezoid grains to form a piezoid bed. The piezoid grains are compacted and settled. The deionization chamber is then sealed in preparation for operation. This is a prerequisite step. It should be appreciated that while this method is described using a piezoid bed as an exemplary embodiment, various embodiments may use different piezoid arrangements.

At 1804, a force is applied to the piezoid bed. For example, a piston applies a uniaxial compressive force or pressure to the piezoid bed. The piston may be hydraulically actuated. This force induces a piezoelectric field or effect in the plurality of piezoid particles in the piezoid bed. The applied force causes properly oriented piezoids to generate electric fields. The electric fields may be of significant strength. These fields will attract charged particles, ions, and/or ionic complexes from the working fluid flowing through the piezoid bed.

As noted above, the use of a hydraulic piston is meant to be exemplary. Other methods can be used to apply the required force to the piezoid bed. The methods can be mechanical and/or electromechanical. A combination of methods may be used. For example, a servo actuator may be used with a flat confining plate to apply the compressive force.

At 1806, a working fluid, for example, brine or a gas containing charged particles, ions, and/or ionic complexes, is admitted to the deionization chamber through the fluid input valve. A volume of working fluid is admitted to fill the interstitial volume of the piezoid bed. The fluid input valve remains open during operation of the deionization chamber. In various embodiments, the working fluid may be other liquids or a gas. The pressure remains applied to the piezoid bed.

A first timed interval commences.

At 1808, the working fluid is output from the deionization chamber. The deionized fluid outlet valve is open to exhaust the working fluid after it has passed through the deionization chamber. As the working fluid passes through the piezoids, the ionic content of the working fluid thus decreases. The pressure remains applied to the piezoid bed.

At 1810, the first timed interval expires.

At 1812, once the first timed interval expires, the deionized outlet valve is shut and the outlet valve is opened.

At 1814, a purge of the piezoid bed is conducted. The piezoid bed requires flushing or purging to remove the charged particles, ions, and/or ionic complexes from the bed. To flush the bed, the pressure is removed from the piezoid bed which eliminates the piezoelectric field. With the brine outlet valve open, the working fluid flows through the bed and flushes the charged particles, ions, and/or ionic complexes from the piezoid bed.

A second timed interval is started.

At 1816, the purge is completed upon expiration of the second time interval.

Force is reapplied to the piezoid bed, causing a regeneration of the piezoelectric fields and the outlet valve is closed. The deionized fluid valve is then opened.

The cycle repeats at 1806.

It should be appreciated that the position and timing of the start of the first and second timed intervals depicted are exemplary and may be at different positions in the method in various embodiments. For example, the first timed interval may commence at 1804. The second timed interval may commence at 1812.

It should be appreciated that the working fluid exhausted through the deionized fluid valve may be recirculated to the inlet to pass through the fluid input valve into the deionization chamber. This may be done following the flushing. In various embodiments, the exhausted working fluid may be ported to another deionization chamber and the process repeated. This may be performed multiple times. The process is stochastic in nature such that the fluid may not be totally cleaned of all charged particles, ions, and/or ionic complexes in a single pass through the deionization chamber. In various embodiments, if the piezoid or piezoid bed is large and the fluid path is long, the fluid may be stripped of charged particles, ions, and/or ionic complexes in a single pass. It should further be appreciated that the piezoid or piezoid bed has a finite ion holding capacity and must be regenerated periodically.

In various embodiments, multiple passes may be required. The number of passes required may depend on the end use of the working fluid, as different uses require different levels of charged particle removal. For example, water for laboratory use has different standards than potable water. Power plant gases may be required to meet certain threshold levels of particles. Thus, the number of stages and the number of passes through the system is a function of the initial input fluid and the desired level of purity of that fluid to be obtained at the final stage. The number of deionization chambers is a also function of flowrate. Therefore, these factors serve as input data in determining the number of stages or passes for a given system, and thus, different applications of exemplary embodiments may have different configurations.

In various embodiments, the working fluid exhausted through the outlet valve may be recirculated to the inlet for input into the deionization chamber again.

It will be readily understood by those persons skilled in the art that the embodiments described above are capable of broad utility and application. Accordingly, while the various embodiments are described in detail in relation to the exemplary embodiments, it is to be understood that this disclosure is illustrative and exemplary of embodiments and is made to provide an enabling disclosure of the exemplary embodiments. The disclosure is not intended to be construed to limit the various embodiments or otherwise to exclude any other such embodiments, adaptations, variations, modifications and equivalent arrangements.

The descriptions are provided of different configurations and features according to exemplary embodiments. For example, configurations and features relating to a desalination system and method using a piezoelectric device have been described. Other embodiments and applications are possible using the principles described herein. Thus, while certain nomenclature and types of applications or hardware are described, other names and applications or hardware usage is possible and the nomenclature provided is done so by way of non-limiting examples only. Further, while particular embodiments are described, these particular embodiments are meant to be exemplary and non-limiting and it further should be appreciated that the features and functions of each embodiment may be combined in any combination as is within the capability of one of ordinary skill in the art.

The figures depict various functionality and features associated with exemplary embodiments. While a single illustrative block, sub-system, device, or component is shown, these illustrative blocks, sub-systems, devices, or components may be multiplied for various applications or different application environments. In addition, the blocks, sub-systems, devices, or components may be further combined into a consolidated unit or divided into sub-units. Further, while a particular structure or type of block, sub-system, device, or component is shown, this structure is meant to be exemplary and non-limiting, as other structure may be able to be substituted to perform the functions described.

Accordingly, the various embodiments are not to be limited in scope by the specific embodiments described herein. Further, although some of the embodiments have been described herein in the context of a particular implementation in a particular environment for a particular purpose, those of ordinary skill in the art should recognize that its usefulness is not limited thereto and that the various embodiments can be beneficially implemented in any number of environments for any number of purposes. Accordingly, the claims set forth below should be construed in view of the full breadth and spirit of the embodiments as disclosed herein. While the foregoing description includes many details and specificities, it is to be understood that these have been included for purposes of explanation only, and are not to be interpreted as limitations of the various embodiments. Many modifications to the embodiments described above can be made without departing from the spirit and scope of this description.

1. A system, comprising:
a piezoid, a plurality of piezoids, or a piezoid bed; and
a working fluid comprising charged particles, ions, and/or ionic complexes.

2. The system of claim 1, wherein the working fluid is a liquid.

3. The system of claim 1, wherein the working fluid is a gas.

4. The system of claim 1, wherein the piezoid, plurality of piezoids, or piezoid bed comprises at least one of monocrystalline quartz and synthetic piezoid particles.

5. The system of claim 1, further comprising:
a means for applying a compressive force to the piezoid, plurality of piezoids, or piezoid bed sufficient to induce a piezoelectric field in the piezoid, plurality of piezoids, or piezoid bed.

6. A system, comprising:
a deionization chamber containing a bed of piezoid particles and comprising a fluid inlet and a fluid outlet;
a fluid input valve fluid coupled to the fluid inlet that allows a working fluid into the deionization chamber;
an outlet valve fluidly coupled to the fluid outlet for exhausting the working fluid during flushing of the piezoid bed; and
a deionized fluid outlet valve fluidly coupled to the fluid outlet for exhausting deionized working fluid from the deionization chamber.

7. The system of claim 6, wherein the working fluid is one of: a liquid comprising one or more of charged particles, ions, and/or ionic complexes and a gas comprising one or more of charged particles, ions, and/or ionic complexes.

8. The system of claim 6, wherein the working fluid is salt water.

9. The system of claim 6, wherein the piezoid bed comprises a plurality of piezoid particles comprising at least one of monocrystalline quartz and synthetic piezoid particles.

10. The system of claim 6, the deionization chamber comprising:
a piston for applying a compressive force to the piezoid bed sufficient to induce a piezoelectric field in each piezoid particle comprising the piezoid bed.

11. The system of claim 10, wherein the piston is hydraulically actuated.

12. The system of claim 6, the deionization chamber further comprising:
a sintered filter located at the outlet.

13. The system of claim 9, wherein the plurality of piezoid particles are of uniform size, non-uniform size, or combinations thereof.

14. The system of claim 10, the deionization chamber further comprising:
a plastically deformable material layer between the piezoid bed and the piston such that the material layer is plastically deformable under the compressive force.

15. The system of claim 6, wherein the piezoid bed comprises a plurality of piezoid particles that are 20-80 mesh.

16. A deionization chamber, comprising:
a piezoid bed comprising a plurality of piezoid particles;
a means for applying a uniaxial compressive force to the piezoid bed sufficient to induce a piezoelectric field in each piezoid particle;
an inlet for admitting a working fluid; and
an outlet for exhausting the working fluid after the working fluid has passed through the piezoid bed.

17. The deionization chamber of claim 16, further comprising:
the inlet being fluidly coupled to a fluid input valve fluid; and
the outlet being fluidly coupled to: a brine outlet valve for exhausting concentrated brine during purging of the piezoid bed when the piezoid bed is not under compression and a deionized fluid outlet valve for exhausting deionized working fluid that has passed through the piezoid bed when the piezoid bed is under compression.

18. The deionization chamber of claim 16, wherein the working fluid is salt water.

19. The deionization chamber of claim 16, wherein the piezoid particles comprise at least one of monocrystalline quartz and synthetic piezoid particles.

20. The deionization chamber of claim 16, wherein the piezoid particles are of uniform size, non-uniform size, or combinations thereof.

21. The deionization chamber of claim 16, the deionization chamber further comprising:
a plastically deformable material layer between the piezoid bed and the means for applying the uniaxial compressive force such that the material layer is plastically deformable under the compressive force.

22. The deionization chamber of claim 16, further comprising:
at least one sintered filter proximate the outlet.

23. The deionization chamber of claim 16, wherein the means for applying a compressive force comprises a hydraulic piston.

24. A method for removing charged particles, ions, and/or ionic complexes from a working fluid, comprising:
applying a working fluid, comprising charged particles, ions, and/or ionic complexes, to a piezoid, a plurality of piezoids, or a piezoid bed;
applying a force to the piezoid, plurality of piezoids, or piezoid bed to induce a piezoelectric effect; and
removing charged particles, ions, and/or ionic complexes from said working fluid through applying the working fluid to the piezoid, plurality of piezoids, or piezoid bed.

25. The method of claim 24, wherein the working fluid is a liquid.

26. The method of claim 24, wherein the working fluid is a gas.

27. The method of claim 24, wherein the piezoid bed comprises a plurality of piezoid particles.

28. The method of claim 24, further comprising:
removing the force from the piezoid, plurality of piezoids, or piezoid bed; and
flushing the piezoid, plurality of piezoids, or piezoid bed with a flushing fluid.

29. The method of claim 24, wherein the flushing fluid is different from the working fluid.

30. The method of any one of claims 24, wherein the piezoid, plurality of piezoids, or piezoid bed comprises one of monocrystalline quartz particles and synthetic piezoid particles.
